(19) United States
(12) Patent Application Publication
(10) Pub. No.: US 2005/0181293 A1
(43) Pub. Date: Aug. 18, 2005

(54) Imprinting device and substrate holding device thereof

(75) Inventor: Heon Lee, Seoul (KR)

Correspondence Address: Richard L. Byrne;WEBB ZIESENHEIM LOGSDON ORKIN & HANSON, P.C., 700 Koppers Building, 436 Seventh Avenue, Pittsburgh, PA, 15219-1818, US

(73) Assignee: Nano & Device Co., Ltd., Seoul (KR)

(21) Appl. No.: 10/834,371

(22) Filed: Apr. 28, 2004

(30) Foreign Application Priority Data
Nov. 19, 2003 (KR) 10-2003-0082069

(51) Int. Cl. G03G 13/20; G03G 13/06; G03C 5/00

(52) U.S. Cl. 430/98; 430/101

(57) ABSTRACT

The present invention relates to an imprinting device for imprinting a pattern, and more particularly, to an imprinting device for imprinting a pattern to a size of nanometer or micrometer dimension. The imprinting device of the present invention is comprised of: a part for forming a hollow portion for accommodating a stamp formed with a pattern and transparent with respect to ultraviolet rays or infrared rays, and a base substrate formed with a polymer hardened by the ultraviolet rays or the infrared rays; an elastic plate made of an elastic material and forming a part of an inner wall of the hollow portion, the elastic plate which is so deformed by a pressure difference between inside and outside of the hollow portion that the stamp is pressed onto the polymer onto the base substrate in order that the pattern formed on a surface of the stamp is transcribed on the polymer; a transparent plate made of a material transparent with respect to the ultraviolet rays or the infrared rays and forming a part of another inner wall facing the elastic plate at the hollow portion, the transparent plate which transmits the ultraviolet rays or the infrared rays to the polymer formed with the pattern so that the polymer is hardened; and a part for discharging air in the hollow portion to be a low pressure state.

### BACKGROUND OF THE INVENTION

1. Field of the Invention

The present invention relates to an imprinting device for imprinting a pattern, and more particularly, to an imprinting device for imprinting an ultra-fine pattern of nanometer or micrometer scale.

2. Description of the Related Art

The technology for forming a pattern to a size of nanometer or micrometer dimension is generally called as nano technology NT. The nano technology is a technology to manufacture and utilize a material, structure, apparatus, mechanism, element or the like, the dimension of which is nanometer scale. In general, a material or an element having a size smaller than 100 nm is classified as an object of the nano technology, and the nano technology is a ground technology that supports the information technology IT and the bio technology BT, which is in close relationship with almost all of the technologies for manufacturing, processing, and application.

The core technology in the nano technology of the above-mentioned significance is the nano processing technology that makes it possible to manufacture and utilize the material, element or the like of nanometer size. The nano processing technology is classified to a top-down type such as a planar technology in a semiconductor element process, and a bottom-up type for manufacturing a nano material and element with the self-assembling technology of the atoms and molecules. The bottom-up type is not practically used due to the technological limitation at present, but the top-down type is commercially used nowadays.

The lithographic technology for forming an ultra-fine pattern sized to several nanometers is one of the core technologies in the nano processing technology. At present, the optical lithographic technology is mainly employed as the lithographic technology for forming the fine pattern. The optical lithography is superior in forming the fine pattern of micron size greater than 100 nm, however, it shows the limitation in forming the ultra-fine pattern having the size smaller than the above.

Accordingly, a new lithographic technology that can substitute for the optical lithographic technology is required in order to form the nano pattern, and there have been proposed X-ray lithographic technology, e-beam lithographic technology, proximal lithographic technology, nano imprinting lithographic technology, etc. in substitution for the optical lithographic technology as the representative technology for forming the nano pattern.

The X-ray lithographic technology makes it possible to form a nano pattern to a size smaller than 20 nm, however, there is a problem that it cannot be employed commercially and requires high costs. The e-beam lithographic technology makes it possible to form the nano pattern at low costs, however, there is a problem that the yield in the process is low. The proximal lithographic technology makes it possible to form a nano pattern to a size of several nanometers that corresponds to the size of an atom or a molecule, however, it is hardly used in fact as it is the typical bottom-up type technology.

To the contrary, the nano imprinting lithographic technology has the advantages that the nano pattern can be formed easily and the yield in the process is high to provide a mass production.

The nano imprinting lithographic technology mentioned above can be used in forming the pattern to the size of micrometer dimension. In other words, the imprinting lithographic technology can be used for forming the micrometer size pattern in substitution for the optical lithographic technology.

Hereinbelow, the imprinting lithographic technology for forming the nanometer or micrometer size pattern is described.

FIGS. 1a through 1c illustrate the imprinting lithography process. As shown in the figures, a stamp 9 formed with a patterned structure 11 of nanometer or micrometer size is located at a position corresponding to a base substrate 19 formed with a polymer 21.

The stamp 9 is formed with a certain pattern structure 11 at the lower surface of the first substrate 10 thereof. A silicon substrate that is easy to process is generally used as the first substrate 10, however, a grass substrate is sometimes used to achieve a transparent stamp 9. The patterned structure 11 formed on the first substrate 10 is generally made of silicon oxide SiOₓ. The patterned structure 11 is formed by layering the silicon oxide on the first substrate 10 and then performing the e-beam lithography process and the etching process.

The base substrate 19 is formed with a polymer 21 layer on the second substrate 20 thereof. The silicon substrate is generally used as the second substrate 20, and a gallium arsenide GaAs substrate, a quartz substrate, or an alumina substrate can be used. The polymer 21 formed on the second substrate 20 is generally made of thermoplastic resin such as polymethylmethacrylate PMMA (hereinafter, referred to as PMMA), etc., and can be made of a resin that is polymerized by ultraviolet rays in case the transparent stamp 9 is used.

Hereinbelow, the imprinting lithography process for imprinting the patterned structure 11 of the stamp 9 on the base substrate 19 is described.

As shown in FIG. 1a, the stamp 9 formed with the patterned structure 11 and the base substrate 19 on which the polymer 21 is layered are located on positions corresponding to each other. In order to form the desired pattern on the base substrate 19, the stamp 9 and the base substrate 19 have to be aligned exactly.

Then, as shown in FIG. 1b, the stamp 9 and the base substrate 19 are pressed toward each other. As they are pressed, the pattern structure 11 formed on the stamp 9 is imprinted on the polymer 21. Appropriate pressure and temperature have to be maintained during the imprinting process.

After such a process, as shown in FIG. 1c, the pressed stamp 9 and the base substrate 19 are detached from each other. Both of the substrates 10 and 19 are divided from each other while being maintained not to damage the pattern 22 formed on the base substrate 19.

The patterned structure 11 formed on the stamp 9 is imprinted on the polymer 21 on the base substrate 19 through the imprinting lithography process as described above.

The stamp 9 and the base substrate 19 have to be aligned exactly in order to imprint the patterned structure 11 formed on the stamp 9 on the base substrate 19 exactly in the above imprinting lithography process, and a constant pressure has to be applied to the aligned stamp 9 and the base substrate 19.

FIG. 2 shows a conventional imprinting device 170 for performing the imprinting lithography process, which shows an imprinting substrate holding device 100 and a chamber 150.

As shown in the figure, the conventional imprinting substrate holding device 100 is comprised of elastic plates 131 and 132, and fixing members 141 and 142 for fixing the elastic plates 131 and 132. The elastic plates 131 and 132 are comprised of a first elastic plate 131 and a second elastic plate 132, and the fixing members 141 and 142 are comprised of a first fixing member 141 and a second fixing member 142.

The elastic plates 131 and 132 are made of polymer such as elastic rubber. A stamp 109 and a base substrate 119 are disposed between the first elastic plate 131 and the second elastic plate 132. In order to imprint the patterned structure of the stamp 109 on the base substrate 119, the first elastic plate 131 and the second elastic plate 132 are applied with pressure. The base substrate 119 is formed with the pattern as the stamp 109 and the base substrate 119 are pressed toward each other by the applied pressure.

The chamber 150 applies pressure to the imprinting substrate holding device 100. While imprinting substrate holding device 100 in which the stamp 109 and the base substrate 119 are held is located in the chamber 150, the pressure in the chamber 150 is raised through the valve 160. The pattern is formed on the base substrate 119 by the pressure in the chamber 150.

However, while the above imprinting substrate holding device 100 is used, the exact position alignment of the stamp 109 and the base substrate 119 may not be maintained not to achieve the desired exact pattern on the base substrate 119. As the pattern is ultra-fine pattern of nanometer or micrometer dimension, the desired pattern on the base substrate 119 cannot be achieved if the stamp 109 and the base substrate 119 are not aligned exactly.

### SUMMARY OF THE INVENTION

The present invention has been proposed to overcome the above-described problems, and it is the object of the present invention to provide an imprinting device that can be form a desired pattern of nanometer or micrometer size exactly on a base substrate by maintaining the exact position alignment during the imprinting process.

Another object of the present invention is to provide an imprinting device of a new optimal construction that can integrally provided with the ultraviolet rays or the infrared rays for the hardening and the high pressure proper for the imprinting in a single device.

Still another object of the present invention is to provide an imprinting device that makes it possible to control the pressure and temperature easily during the imprinting process to achieve an optimal pattern.

To achieve the above object, the present invention provides an imprinting device comprising: means for forming a hollow portion for accommodating a stamp formed with a pattern and transparent with respect to ultraviolet rays or infrared rays, and a base substrate formed with a polymer hardened by the ultraviolet rays or the infrared rays; an elastic plate made of an elastic material and forming a part of an inner wall of the hollow portion, the elastic plate which is so deformed by a pressure difference between inside and outside of the hollow portion that the stamp is pressed onto the polymer onto the base substrate in order that the pattern formed on a surface of the stamp is transcribed on the polymer; a transparent plate made of a material transparent with respect to the ultraviolet rays or the infrared rays and forming a part of another inner wall facing the elastic plate at the hollow portion, the transparent plate which transmits the ultraviolet rays or the infrared rays to the polymer formed with the pattern so that the polymer is hardened; and a means for discharging air in the hollow portion to be a low pressure state.

It is preferable that the imprinting device of the present invention further comprises: a sealed high-pressure chamber having at least a part of a surface of the elastic plate exposed outward of the hollow portion as an inner wall thereof; and a pressing means for raising a pressure in the high-pressure chamber so that the elastic plate is deformed toward the inside of the hollow portion.

It is preferable that the imprinting device of the present invention further comprises a light transmitting means for applying the ultraviolet rays or the infrared rays through the transparent plate.

It is preferable that the imprinting device of the present invention further comprises a light source for providing the ultraviolet rays or the infrared rays.

It is preferable that the imprinting device of the present invention further comprises a temperature control device for controlling a temperature of the pattern of the polymer.

It is preferable that the imprinting device of the present invention further comprises an auxiliary aligning means for fixing the stamp and the base substrate so that a position alignment of the stamp and the base substrate accommodated in the hollow portion is maintained.

It is preferable that the auxiliary aligning means in the imprinting device of the present invention is so constructed as to use a magnetic force between a first magnetic member fixed on a certain position on the inner wall of the hollow portion and a second magnetic member assembled with the stamp or the base substrate.

### BRIEF DESCRIPTION OF THE DRAWINGS

Other objects and aspects of the present invention will become apparent from the following description of preferred embodiment with reference to the accompanying drawings in which:

FIGS. 1a through 1c are perspective views showing the conventional imprinting lithography process;

FIG. 2 is a sectional view of a conventional imprinting device, in which an imprinting substrate holding device and an imprinting chamber are schematically shown;

FIGS. 3a and 3b are schematic views that illustrate the main technical idea of the present invention;

FIGS. 4a through 4c are schematic views that illustrate various embodiments of the present invention;

FIG. 5 is a sectional view showing the imprinting device according to the first embodiment of the present invention;

FIG. 6 is a partially cutaway perspective view of the accommodating member according to the first embodiment of the present invention;

FIG. 7 is a perspective view showing the elastic plate according to the first embodiment of the present invention;

FIG. 8 is a perspective view showing the transparent plate according to the first embodiment of the present invention;

FIG. 9 is a perspective view showing the buffering member according to the first embodiment of the present invention;

FIG. 10 is a partially cutaway perspective view showing the fixing parts and the assembling means according to the first embodiment of the present invention;

FIG. 11 is a partially cutaway perspective view showing the high-pressure chamber according to the first embodiment of the present invention;

FIGS. 12a through 12c are sectional views that illustrate the operation of the imprinting device according to the first embodiment of the present invention;

FIG. 13 is a sectional view showing the imprinting device in which the second fixing member and the chamber are formed integrally according to the first embodiment of the present invention;

FIG. 14 is a sectional view of the imprinting device according to the second embodiment of the present invention;

FIG. 15 is a sectional view of the imprinting device according to the third embodiment of the present invention;

FIG. 16 is a sectional view of the imprinting device according to the fourth embodiment of the present invention;

FIG. 17 is a sectional view of the imprinting device according to the fifth embodiment of the present invention;

FIGS. 18a through 18c are sectional views showing the operation of the imprinting device according to the fifth embodiment of the present invention;

FIG. 19 is a sectional view of the imprinting device according to the sixth embodiment of the present invention;

FIG. 20 is a sectional view of the imprinting device according to the seventh embodiment of the present invention;

FIG. 21 is a sectional view of the imprinting device according to the eighth embodiment of the present invention; and

FIG. 22 is a sectional view of the imprinting device according to the ninth embodiment of the present invention.

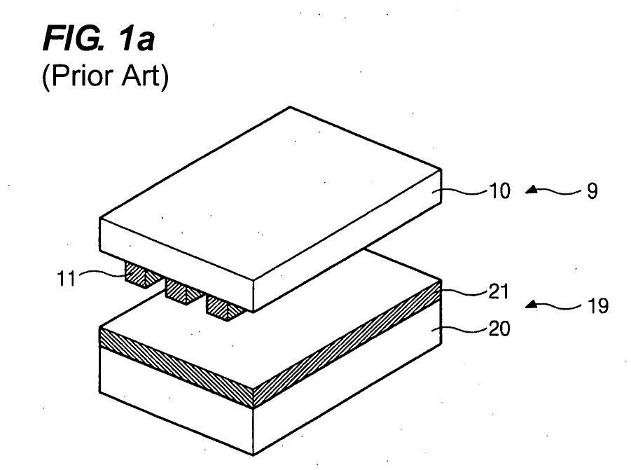

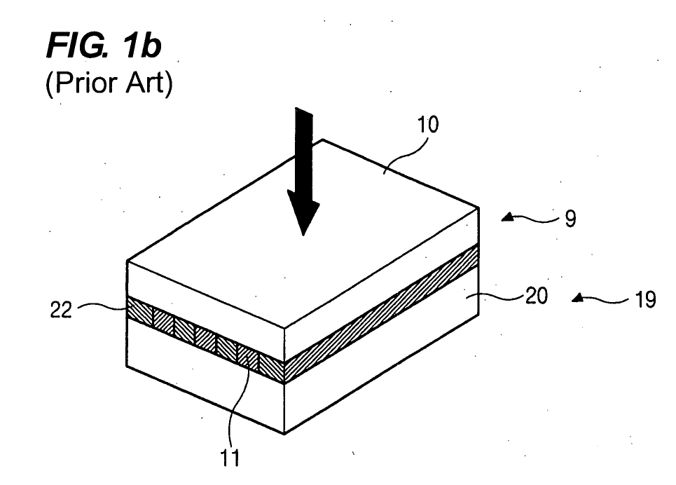

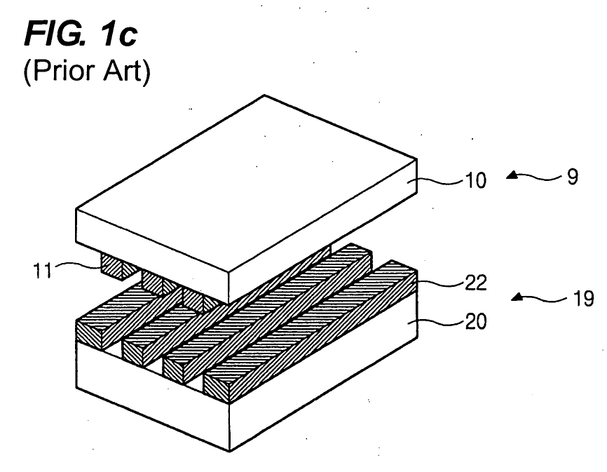

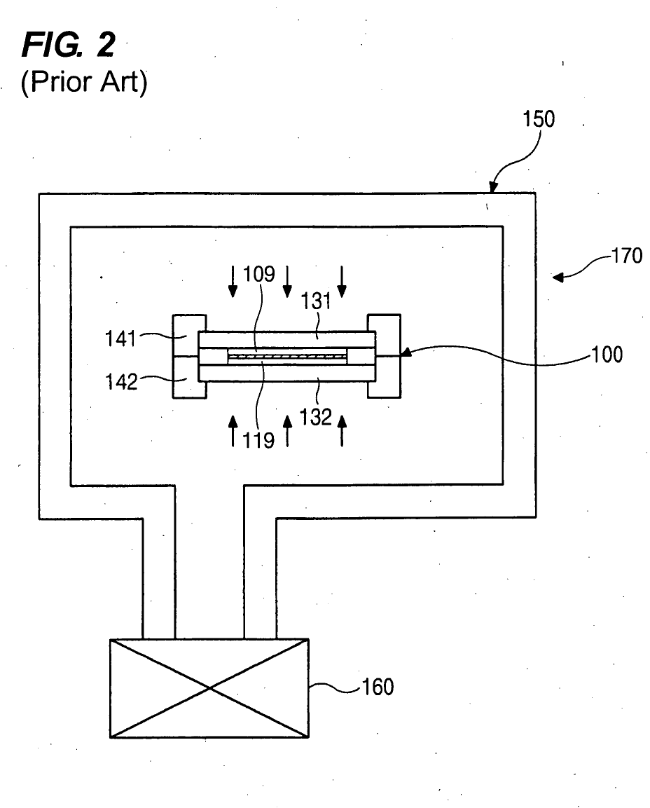

### DESCRIPTION OF THE PREFERRED EMBODIMENTS

Reference now should be made to the drawings, in which the same reference numerals are used throughout the different drawings to designate the same or similar components.

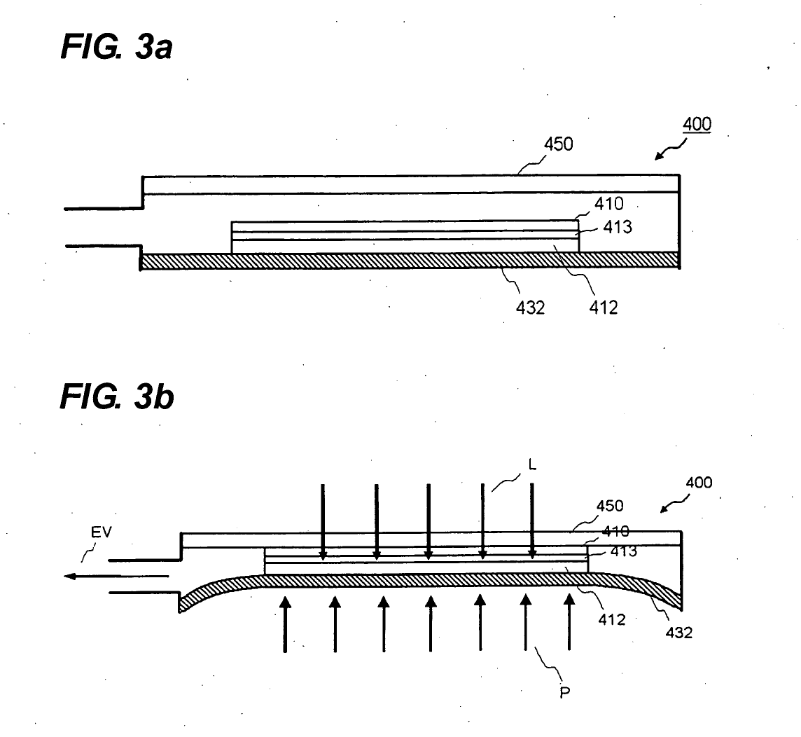

FIGS. 3a and 3b are schematic views that illustrate the main technical idea of the present invention. The present invention provides a substrate holder assembly 400 as shown in the figures. As shown in FIG. 3a, the imprinting mask 410 and the base substrate 412 coated with polymer 413 that are aligned with respect to each other are loaded in the sealed hollow portion 430 of the substrate holder assembly 400. An elastic plate 432 is disposed at the lower wall of the hollow portion 430, and a transparent plate 450 is disposed on the upper wall of the hollow portion 430. As the air in the hollow portion 430 is discharged through a discharge line, the elastic plate 432 is deformed toward the inside of the hollow portion 430 by the pressure difference between the inside and the outside of the hollow portion 430 as shown in FIG. 3b. One side of the elastic plate 432 becomes the inner wall of the hollow portion 430 and the other side of the elastic plate 432 becomes the inner wall of a pressing chamber (not shown), so the pressure applied to the elastic plate 432 becomes greater when the pressure in the pressing chamber is raised. The imprinting stamp 410 is pressed toward the polymer 413 by the deformation of the elastic plate 432, and therefore, the fine pattern formed on the imprinting stamp 410 is transcribed onto the polymer 413.

In such a situation, ultraviolet rays or infrared rays are projected to harden the polymer 413. The projected ultraviolet rays or the infrared rays arrive at the polymer 413 through the transparent plate 450 equipped at the upper side of the substrate holder assembly 400 and the imprinting stamp 410, by which the polymer 413 is hardened.

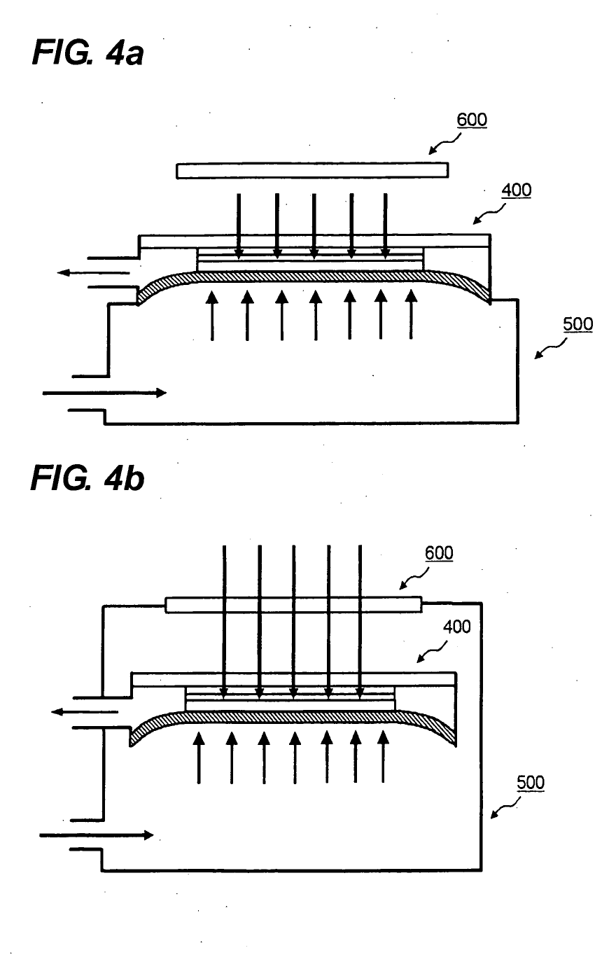

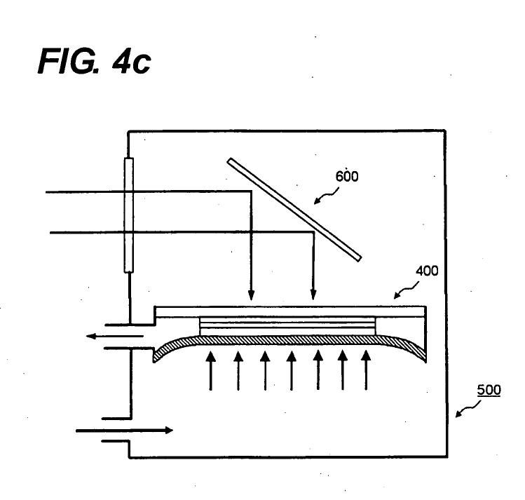

The construction of the imprinting device having the above-described substrate holder assembly 400 can be modified in a variety of manners including the examples shown in the accompanying FIGS. 4a through 4c. FIG. 4a shows the example of the imprinting device in which a light projecting assembly 600 is disposed over the transparent plate and the pressing chamber 500 is disposed under the elastic plate. The light projecting assembly 600 can imbed a light source that generates the ultraviolet rays or the infrared rays.

FIG. 4b shows the example that the ultraviolet rays or the infrared rays are projected through the window at the upper area of the device by installing a light source (not shown) at the outside, and the entire substrate holder assembly 400 is installed in the pressing chamber 500. In such a case, the imprinting mask and the polymer are also pressed by the deformation of the elastic plate due to the pressure difference between the inside of the pressing chamber 500 and the hollow portion. The light source (not shown) can be a lamp that generates the ultraviolet rays or the infrared rays, and the light projected from the lamp located at a distant position can be transmitted to the window through an optical fiber or a light guide.

FIG. 4c shows another modification in which the light is projected into the device through the window installed at the side wall of the device, and an optical system such as a mirror is installed in the device so that the light is transmitted to the transparent plate of the substrate holder assembly 400.

Hereinbelow, the preferred embodiments of the present invention will be described in greater detail with reference to the accompanying drawings.

First Embodiment

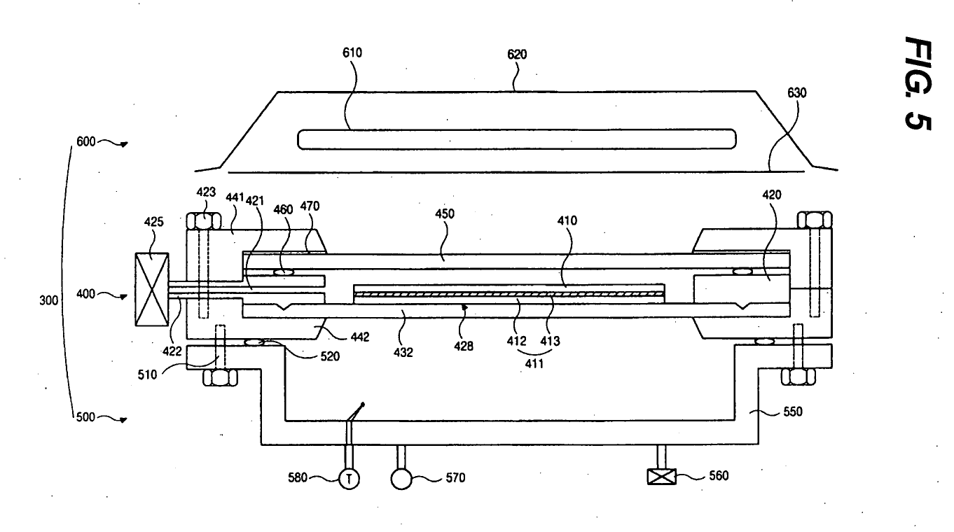

FIG. 5 shows the imprinting device 300 according to the first embodiment of the present invention.

The imprinting device 300 according to the first embodiment of the present invention is the device that preferably imprints the pattern formed on the stamp 410 on the polymer 413 of the base substrate 411 by imprinting the pattern formed on the stamp 410 on the polymer 413 of the base substrate 411 with a high pressure and by hardening the pattern with the light such as the ultraviolet rays or the infrared rays projected on the imprinted pattern.

The imprinting device 300 according to the first embodiment of the present invention has a substrate holder assembly 400 for holding the aligned state of the stamp 410 and the base substrate 411 in a vacuum state, a pressure applying assembly 400 assembled with the substrate holder assembly 400 and used for applying the pressure for imprinting the pattern, and a light projecting assembly 600 for projecting the light such as the ultraviolet rays or the infrared rays to perform the UV curing or the thermal curing on the pattern formed on the polymer 413 of the base substrate 411.

Hereinbelow, the imprinting device according to the first embodiment of the present invention will be described in detail with reference to FIGS. 5 through 11.

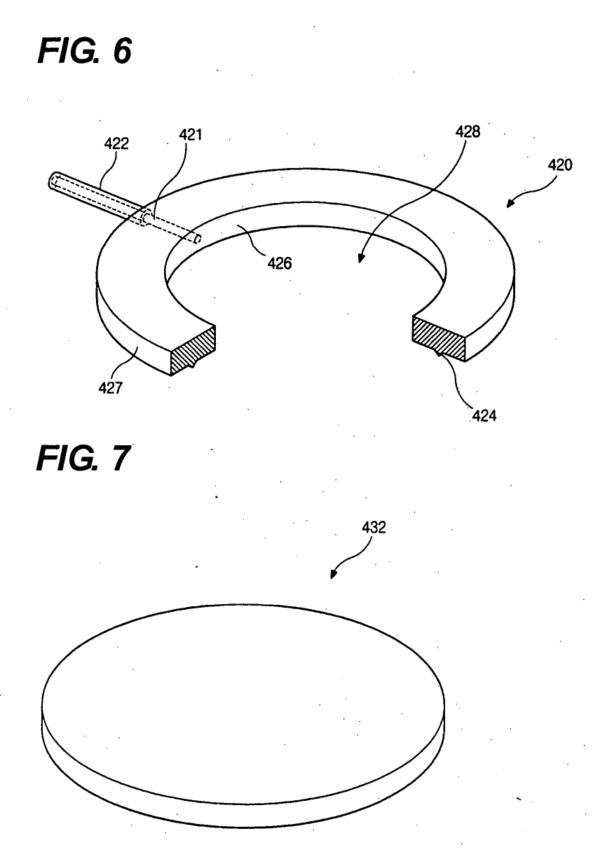

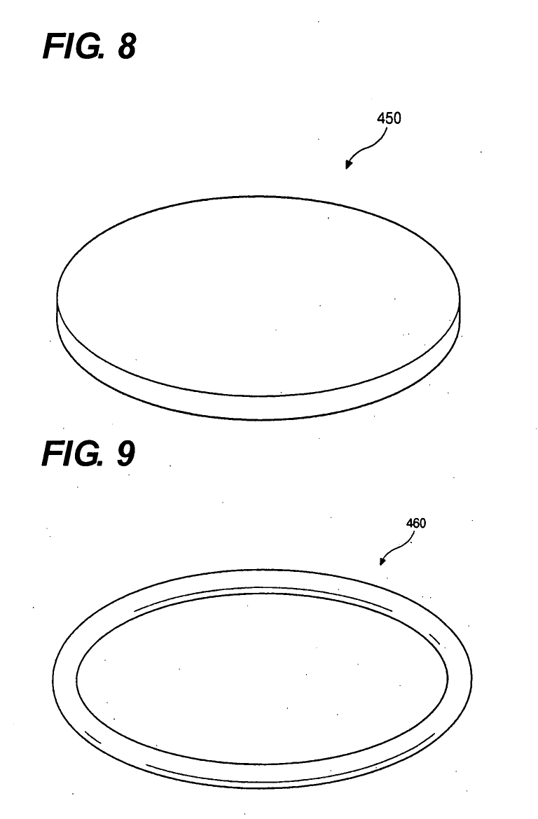

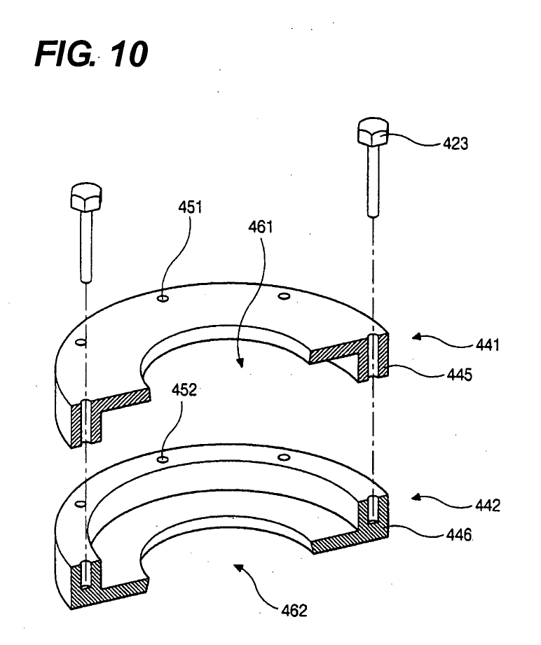

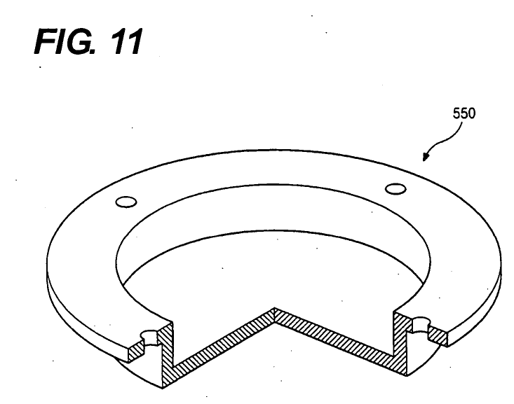

FIG. 6 is a partially cutaway perspective view of the accommodating member 420, FIG. 7 is a perspective view showing the elastic plate 432, FIG. 8 is a perspective view showing the transparent plate 450, FIG. 9 is a perspective view showing the buffering member 460, FIG. 10 is a partially cutaway perspective view showing the fixing parts 441 and 442 and the assembling means 423 that passes through the fixing parts 441 and 442, and FIG. 11 is a partially cutaway perspective view showing the chamber 550.

The accommodating member 420 has a shape of a ring having a first hollow portion 428 open upward and downward at the inner circumference thereof. The accommodating member 420 has a discharge port 421 that penetrates the inner circumference 426 and the outer circumference 427 thereof, and a discharge pipe 422 connected with the discharge port 421 and a first valve 425. The lower side of the accommodating member 420 is formed with a protrusion 424 protruding outward. Meanwhile, the accommodating member 420 is made of metallic material to minimize the deformation of shape.

At first, the substrate holder assembly 400 is described.

The substrate holder assembly 400 maintains the preferable position alignment state of the stamp 410 and the base substrate 411 by evacuating the first hollow portion 428 in which the stamp 410 and the base substrate 411 are accommodated.

Further, the substrate holder assembly 400 employs the transparent plate 450 that is transparent with respect to the light, and the pattern is formed easily on the polymer 413 as the pattern formed on the polymer 413 undergoes UV curing or thermal curing by the light projected during the imprinting lithography process. The polymer 413 becomes a resin that is polymerized by the ultraviolet rays or the infrared rays, and the stamp 410 is also made of a material transparent with respect to the ultraviolet rays or the infrared rays such as quartz.

The substrate holder assembly 40 has the accommodating member 420 formed with the first hollow portion 428 for accommodating the stamp 410 and the base substrate 411 and having the discharge port 421 connected with the first valve 425 that is the means for discharging the air in the first hollow portion 428, and a sealing member for sealing the first hollow portion 428 with respect to the outside.

The sealing member is comprised of an elastic plate 432 that is in contact with the lower surface of the accommodating member 420, a first buffering member 460 that is in contact with the upper surface of the accommodating member 420, the transparent plate 450 located on the first buffering member 460, and a fixing means for fixing the accommodating member 420, the first elastic plate 432 and the transparent plate 450 with each other.

The fixing means is comprised of fixing parts 441 and 442, and a first assembling means 423 for fixing the fixing parts 441 and 442 with each other. Here, the fixing parts 441 and 442 are comprised of a first fixing member 441 and a second fixing member 442 that face to each other.

A second buffering member 470 is disposed between the first fixing member 441 and the transparent plate 450.

The accommodating member 420 has the first hollow portion 428 open upward and downward at the inner circumference 426 thereof. Furthermore, the accommodating member 420 has the discharge port 421 penetrating the inner circumference 426 and the outer circumference 427 thereof, and the discharge pipe 422 connected with the discharge port 421 and the first valve 425. The accommodating member 420 is formed with the protrusion 424 protruding outward at the lower surface thereof.

Meanwhile, the accommodating member 420 is made of metallic material to minimize the deformation of the shape thereof, and preferably, the accommodating member 420 is formed to a ring shape.

The stamp 410 and the base substrate 411 are accommodated in the first hollow portion 428 of the accommodating member 420. The first hollow portion 428 forms a closed space together with the elastic plate 432, the first buffering member 460, and the transparent late 450.

The discharge port 421 and the discharge pipe 422 formed on the accommodating member 420 connect the first valve 425 to the first hollow portion 428 that forms the closed space together with the elastic plate 432, the first buffering member 460, and the transparent plate 450, to control the pressure in the first hollow portion 428.

For example, the first valve 425 begins to operate as the stamp 410 and the base substrate 411 are accommodated at the first hollow portion 428 while they are aligned at the position to form the pattern, and then the air in the hollow portion 428 is discharged through the discharge port 421 and the discharge pipe 422, whereby the first hollow portion 428 is evacuated. The elastic plate 432 is applied with the pressure caused by the difference of pressure between the first hollow portion 428 and the outside, thereby deforming the elastic plate 432 elastically toward the direction facing the transparent plate 450. The stamp 410 is contacted with the transparent plate 450 to press the transparent plate 450 as the elastic plate 432 is deformed elastically, and then the transparent plate 450 presses the stamp 410 according to the reaction of such a state. Accordingly, the elastic plate 432 and the transparent plate 450 press the stamp 410 and the base substrate 411, and position alignment state of the stamp 410 and the base substrate 411 is then fixed.

The protrusion 424 formed on the lower surface of the accommodating member 420 is pushed into the elastic plate 432 having the elasticity. In particular, the second fixing member 442 presses the elastic plate 432, and the protrusion 424 is pushed into the elastic plate 432 by the applied pressure so as to prevent the inflow of the outside air into the hollow portion 428.

The first fixing member 441 presses the transparent plate 450, and the first buffing member 460 is deformed by the applied pressure so as to prevent the inflow of the outside air into the first hollow portion 428.

Accordingly, the first hollow portion 428 is sealed completely against the outside, and the outside air cannot enter the first hollow portion 428 while the first valve 425 is operating, whereby the first hollow portion 428 is kept to a perfect vacuum state.

Furthermore, the movement of the first elastic plate 432 is prevented by the protrusion 424, and accordingly, the movement of the stamp 410 and the base substrate 411 placed on the elastic plate 432 is prevented.

The number of protrusions 424 formed on the lower surface of the accommodating member 420 can be as great as possible. As the number of protrusions 424 increases, the first hollow portion 428 can be sealed more perfectly against the outside, and the accommodating member 420 can fix the elastic plate 432 more steadfastly.

The elastic plate 432 has the elasticity, and is contacted with the accommodating member 420 to seal the first hollow portion 428 against the outside. The elastic plate 432 preferably has the shape of a disc, and is made of elastic polymer material such as polydimethylsiloxane or silicon rubber.

The first buffering member 460 is disposed between the transparent plate 450 and the accommodating member 420 to seal the first hollow portion 428 against the outside, and prevents the damage to the transparent plate 450. The first buffering member 460 is made of elastic material, and preferably has the shape of a ring.

The transparent plate 450 is made of transparent material such as quartz, through which the light projected from the outside for the UV curing or the thermal curing of the pattern imprinted on the polymer 413 during the imprinting lithography process passes. The transparent plate 450 is preferably shaped into a disc. The transparent plate 450 is fixed by the first fixing member 441, and pushes the first buffering member 460 to seal the first hollow portion 428 against the outside.

Since the transparent plate 450 is made of the material such as quartz that is not liable to be deformed by the pressure applied from the outside, a second buffering member 470 having elasticity is disposed between the first fixing member 441 and the transparent plate 450 in order to prevent the drawback caused by the direct contact between the first fixing member 441 and the transparent plate 450. Meanwhile, the second buffering member 470 can also have the shape of a ring like the first buffering member 460.

The first fixing member 441 and the second fixing member 442 respectively have a second hollow portion 461 and a third hollow portion 462 at the inner circumference thereof that are open upward and downward, and face to each other.

The first fixing member 441 and the second fixing member 442 are respectively formed with a first assembly portion 445 and a second assembly portion 446 that protrude toward each other and are formed along the outer edge thereof, and the first assembly portion 445 and the second assembly portion 446 are formed with a plurality of assembly holes 451 and 452. A first assembling means 423 fixes the first fixing member 441 and the second fixing member 442 with each other through the assembly holes 451 and 452 formed on the first assembly portion 445 and the second assembly portion 446. A screw or the like is employed as the first assembling means 423.

The first fixing member 441 and the second fixing member 442 assembled by the first assembling means 423 functions to fix transparent plate 450, the second elastic plate 432, and the accommodating member 420 by fastening them together.

The first fixing member 441 assembled by the first assembling means 423 presses the transparent plate 450, thereby deforming the shape of the first buffering member 460. The second fixing member 442 presses the elastic plate 432, and therefore, the protrusion 424 formed on the lower surface of the accommodating member 420 is pushed into the elastic plate 432. Therefore, the first hollow portion 428 is sealed perfectly against the outside, and the elastic plate 432 is fixed not to move.

Meanwhile, the second hollow portion 461 let the light projected via the light projection assembly 600 pass through the transparent plate 450 during the imprinting lithography process.

The third hollow portion 462 transmits the pressure applied through the pressure apply assembly 500 to the elastic plate 432 during the imprinting lithography process. When the first hollow portion 428 in the accommodating member 420 is evacuated, the pressure is applied to the elastic plate 432 through the third hollow portion 462.

In such a situation, the first hollow portion 428, the second hollow portion 461, and the third hollow portion 462 are preferably arranged in a coaxial manner, and the central axes of them are preferably identical to the central axis of the stamp 410 and the base substrate 411.

According to the substrate holder assembly 400 having the above construction, before the imprinting lithography process, the first hollow portion 428 is evacuated to fix the position arrangement state of the stamp 410 and the base substrate 411.

Next, the pressure apply assembly 500 is described.

The pressure apply assembly 500 applies pressure high enough to imprint the pattern onto the polymer 413 of the base substrate 411 to the substrate holder assembly 400.

The pressure apply assembly 500 has a chamber 550 for applying the pressure to the elastic plate 432, and a second valve 560 as a means for applying air pressure into the inner space of the chamber 550. The pressure apply assembly 500 can additionally have a pressure gauge 570 for gauging the pressure in the chamber 550 and a temperature gauge 580 for gauging the temperature in the chamber 550.

The chamber 550 has an inner space that is open toward the elastic plate 432, and assembled with the second fixing member 442 by the second assembling means 510. The third buffering member 520 is disposed between the chamber 550 and the second fixing member 442, by which the inner space of the chamber 550 is sealed against the outside and the defect that may be caused by the assembly between the chamber 550 and the second fixing member 442 is prevented. The third buffering member 520 preferably has the shape of a ring.

As the second valve 560 begins to operate, the air flows into the inner space of the chamber 550 to raise the pressure therein, and the raised pressure has influence on the substrate holder assembly 400. In particular, the pressure in the chamber 550 has influence on the elastic plate 432 through the third hollow portion 462.

The high pressure applied to the elastic plate 432 is then applied to the stamp 410 and the base substrate 411 of which position alignment has been set in the vacuum state, and the pattern formed on the stamp 410 is imprinted on the polymer 413 of the base substrate 411.

The pressure gauge 570 and the temperature gauge 580 are used to measure the pressure and the temperature of the inner space of the chamber 550.

Next, the light projection assembly 600 is described.

The light projection assembly 600 projects the light onto the pattern imprinted on the base substrate 411 by the high pressure to perform the UV curing or the thermal curing, by which the pattern is easily formed on the base substrate 411.

The light projection assembly 600 is equipped with a lamp 610 for projecting the light, a reflection plate 620 for reflecting the light projected from the lamp 610, and a shutter 630 for passing the projected light selectively.

An ultraviolet lamp or a halogen lamp can be employed as the lamp 610 as required. The ultraviolet lamp that irradiates the ultraviolet rays is employed for the UV curing of the pattern formed on the polymer 613, and the halogen lamp that irradiates the infrared rays is employed for the thermal curing.

The reflection plate 620 reflects the light irradiated from he lamp 610 toward the direction that the substrate holder assembly 500 is located. As the shutter 630 is opened or closed, the ultraviolet rays or the infrared rays from the employed lamp 610 are transmitted or blocked.

As mentioned above, the imprinting device 300 having the substrate holder assembly 400, the pressure apply assembly 500 and the light projection assembly 600 imprints the desired pattern on the polymer 413 of the base substrate 411 by projecting the light and applying the high pressure to the stamp 410 and the base substrate 411 of which position has been fixedly aligned by the substrate holder assembly 400.

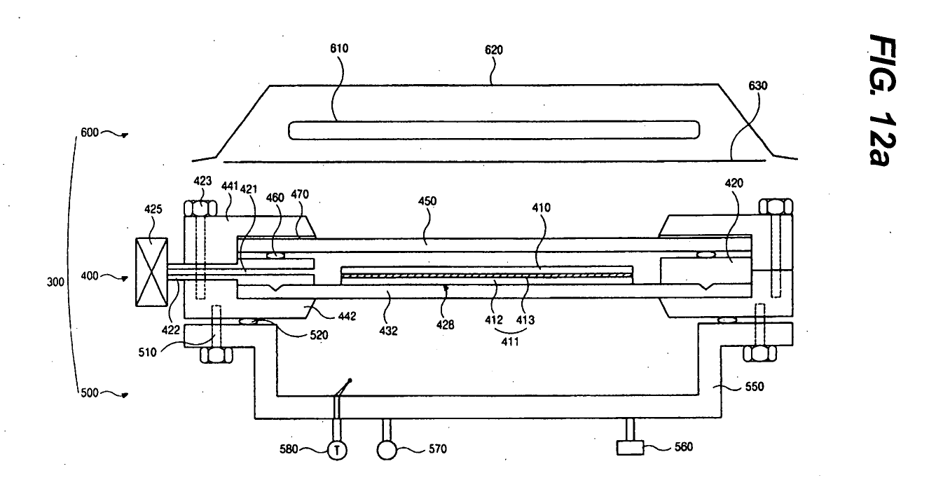

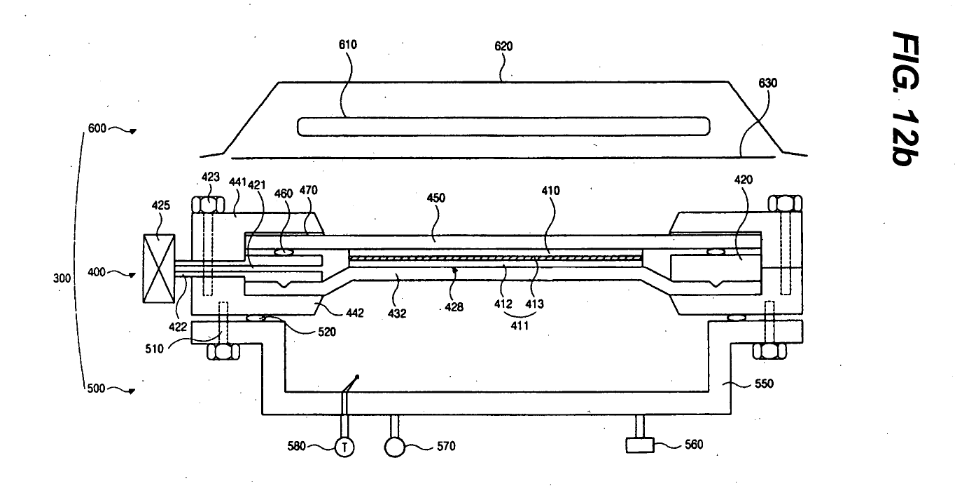

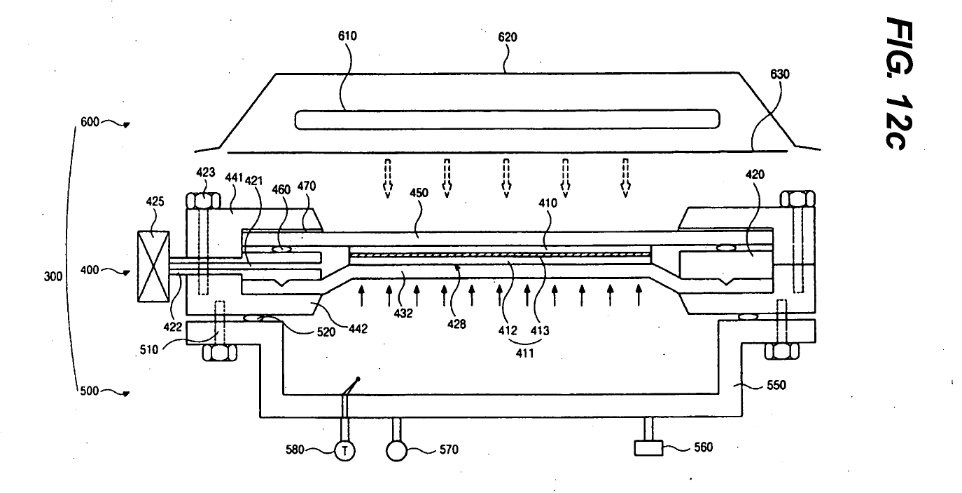

Hereinafter, the operation of the imprinting device 300 according to the first embodiment of the present invention is described with reference to FIGS. 12a through 12c.

As shown in FIG. 12a, the stamp 410 and the base substrate 411 are accommodated in the first hollow portion 428 while they are placed on the elastic plate 432. The stamp 410 and the base substrate 411 had been aligned at an exact position in advance.

The first fixing member 441 and the second fixing member 442 are assembled with each other by the assembling means 423, and the assembled first fixing member 441 and the second fixing member 442 press the transparent plate 450 and the elastic plate 432, respectively. The transparent plate 450 presses the first buffering member 460, and the protrusion 424 formed on the lower surface of the accommodating member 420 is pushed into the elastic plate 432 to form a closed space at the first hollow portion 428. Further, the elastic plate 432 is fixed so that it cannot be moved.

Next, as shown in FIG. 12b, the first valve 425 connected to the discharge pipe 422 begins to operate. The first valve 425 discharges the air in the first hollow portion 428 toward the outside to vacuumize the closed first hollow portion 428.

As the first hollow portion 428 is evacuated, the elastic plate 423 is deformed toward the direction facing the transparent plate 450. As the elastic plate 432 is deformed, the stamp 410 is contacted with the transparent plate 450 to press the transparent plate 450, and accordingly, the transparent plate 450 presses the stamp 410 by the reaction of such a state.

Therefore, the elastic plate 432 and the transparent 450 press the stamp 410 and the base substrate 411, so position alignment of the stamp 410 and the base substrate 411 is set steadfastly.

Next, as shown in FIG. 12c, the second valve 560 begins to operate to raise the pressure in the chamber 550, and the light is projected through the light projection assembly 600.

The pressure in the chamber 550 increases enough to imprint the pattern formed on the stamp 410 sufficiently onto the polymer 413 of the base substrate 411. The pressure in the chamber 550 is applied to the elastic plate 432 through the third hollow portion 462, and the pressure applied to the elastic plate 432 is then transmitted to the stamp 410 and the base substrate 411. Therefore, the pattern formed on the stamp 410 is imprinted on the polymer 413 of the base substrate 411.

The light is projected onto the imprinted polymer 413, so the polymer 413 is hardened by the ultraviolet or the heat. The pattern is preferably imprinted on the polymer 413 by the UV curing or the thermal curing.

As mentioned above, the imprinting device 300 according to the first embodiment of the present invention preferably imprints the pattern formed on the stamp 410 onto the polymer 413 of the base substrate 411 by applying high pressure and projecting the light onto the stamp 410 and the base substrate 411 that have been aligned preferably in the vacuum state.

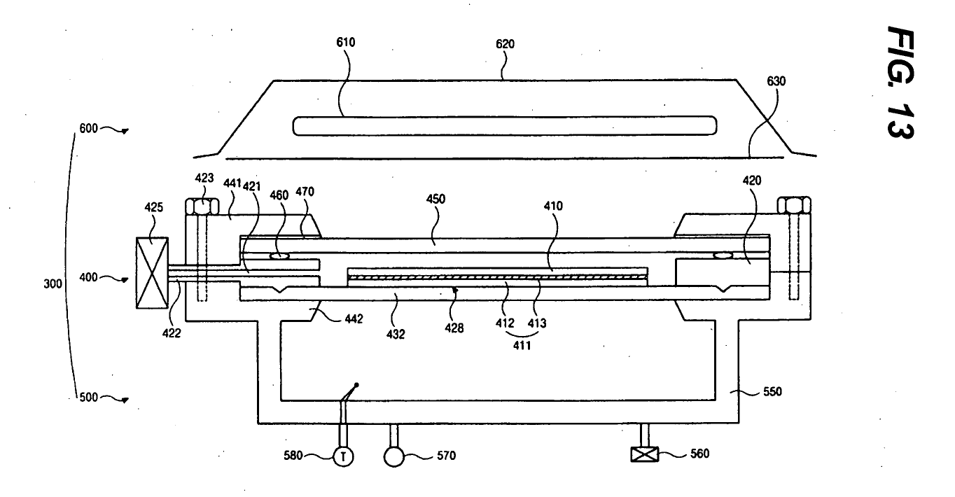

Meanwhile, in the imprinting device 300 according to the first embodiment of the present invention, as shown in FIG. 13, the pressure apply assembly 500 and the substrate holder assembly 300 can be manufactured in a body, and in case they are constructed integrally, the second fixing member 442 and the chamber 550 are constructed in a body.

Second Embodiment

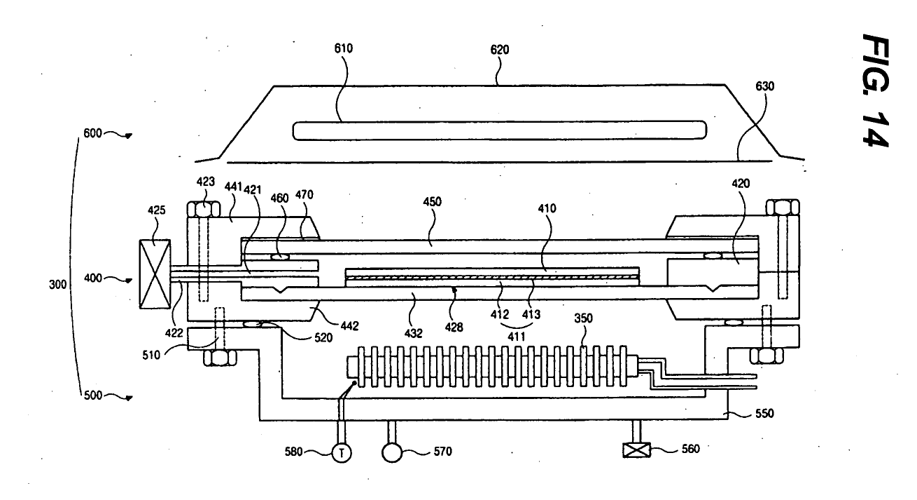

FIG. 14 shows the imprinting device 300 according to the second embodiment of the present invention.

The second embodiment of the present invention is one of the modifications of the first embodiment of the present invention, and the description of the parts identical to or corresponding to those in the first embodiment is omitted and the additional or the modified elements are described below.

The imprinting device 300 according to the second embodiment of the present invention has a temperature control device 350 for raising or lowering the processing temperature during the imprinting lithography process.

The temperature control device 350 installed in the chamber 550 changes the processing environment to a high temperature or a low temperature rapidly by circulating the fluid of high or low temperature.

As the fluid of high temperature circulates in the temperature control device 350 during the imprinting lithography process, the imprinting device 300 is changed to the high temperature environment rapidly to form the pattern on the polymer 313 of the base substrate 311 easily.

Moreover, as the fluid of low temperature circulates in the temperature control device 350 after the pattern has been formed, the imprinting device 300 is changed to the low temperature environment rapidly to prevent the deficiency of pattern that may be caused by the thermal expansion of the pattern of the polymer 313 that has been imprinted in the high temperature environment.

As mentioned above, the imprinting device 300 according to the second embodiment of the present invention is equipped with the temperature control device 350 in the chamber 550, so the temperature of the imprinting device 300 can be controlled easily to form the desired pattern easily.

Third Embodiment

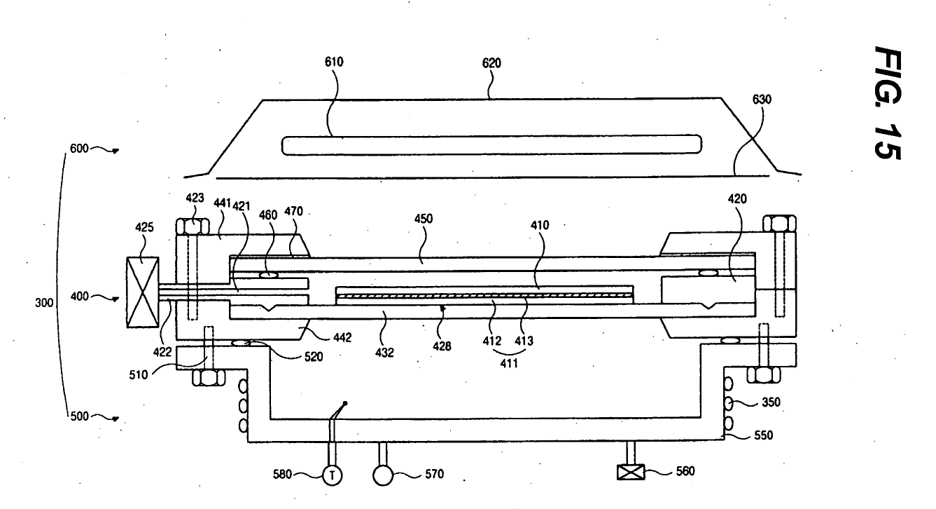

FIG. 15 shows the imprinting device 300 according to the third embodiment of the present invention.

The third embodiment of the present invention is one of the modifications of the first embodiment of the present invention, and the description of the parts identical to or corresponding to those in the first embodiment is omitted and the additional or the modified elements are described below.

The imprinting device 300 according to the third embodiment of the present invention has a temperature control device 350 for raising or lowering the processing temperature during the imprinting lithography process.

The temperature control device 350 installed around the chamber 550 changes the processing environment to a high temperature or a low temperature rapidly by circulating the fluid of high or low temperature.

As the fluid of high temperature circulates in the temperature control device 350 during the imprinting lithography process, the imprinting device 300 is changed to the high temperature environment rapidly to form the pattern on the polymer 313 of the base substrate 311 easily.

Moreover, as the fluid of low temperature circulates in the temperature control device 350 after the pattern has been formed, the imprinting device 300 is changed to the low temperature environment rapidly to prevent the deficiency of pattern that may be caused by the thermal expansion of the pattern of the polymer 313 that has been imprinted in the high temperature environment.

As mentioned above, the imprinting device 300 according to the second embodiment of the present invention is equipped with the temperature control device 350 around the chamber 550, so the temperature of the imprinting device 300 can be controlled easily to form the desired pattern easily.

Fourth Embodiment

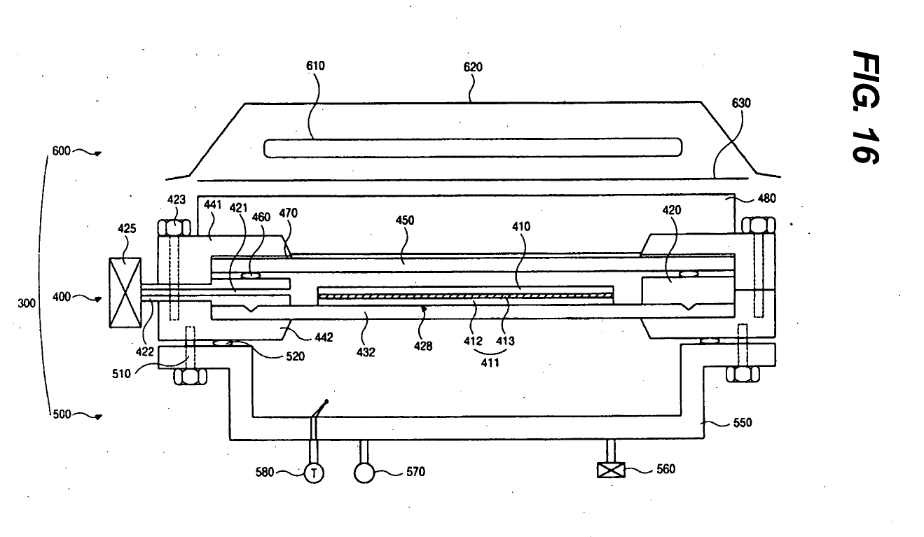

FIG. 16 shows the imprinting device 300 according to the fourth embodiment of the present invention.

The fourth embodiment of the present invention is one of the modifications of the first embodiment of the present invention, and the description of the parts identical to or corresponding to those in the first embodiment is omitted and the additional or the modified elements are described below.

The imprinting device 300 according to the fourth embodiment of the present invention additionally has a protecting member 480 for protecting the transparent plate 450.

The transparent plate 450 is made of the material transparent to the light such as quartz, so it can be damaged easily by the impact from the outside. Therefore, as the protecting member 480 is disposed over the transparent plate 450, the transparent plate 450 is protected from the outside impact.

The protecting member 480 is disposed over the transparent plate 450, and form-fittingly assembled with the second hollow portion 461 so as to be fixed.

The protecting member 480 is made of the material transparent to the light such as the quartz as in the case of the transparent plate 450 in order to pass the light irradiated from the light projection assembly 600.

As mentioned above, the imprinting device 300 according to the fourth embodiment of the present invention can protect the transparent plate 450 from the outside impact as it is additionally equipped with the protecting member 480 over the transparent plate 450.

Fifth Embodiment

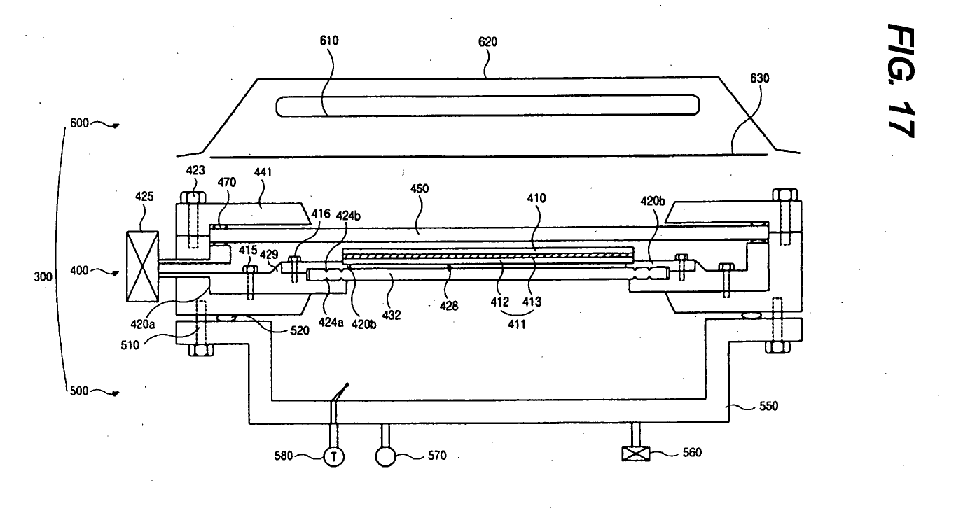

FIG. 17 shows the imprinting device 300 according to the fifth embodiment of the present invention.

The fifth embodiment of the present invention is one of the modifications of the first embodiment of the present invention, and the description of the parts identical to or corresponding to those in the first embodiment is omitted and the additional or the modified elements are described below.

As shown in the figure, the imprinting device 300 according to the fifth embodiment of the present invention has a substrate holder assembly that is different from that of the first embodiment.

The substrate holder assembly 400 has a sealing member for sealing the first hollow portion 428a in which the stamp 410 and the base substrate 411 are accommodated with respect to the outside, and the first valve 425 that is the means for discharging the air in the first hollow portion 428a.

The sealing member is comprised of a first accommodating member 420a having the first hollow portion 428a, a second accommodating member 420b in which the stamp 410 and the base substrate 411 are accommodated, an elastic plate 432 disposed fixedly between the first accommodating member 420a and the second accommodating member 420b, a transparent plate 450 that seals the upper part of the first hollow portion 428a with respect to the outside, and a fixing means for pressing the transparent plate 450 and the first accommodating member 420a. A first buffering member 460 that is a buffing means is additionally disposed between the transparent plate 450 and the first accommodating member 420a, and a second buffering member 470 is additionally disposed between the transparent plate 450 and the fixing means.

The fixing means is comprised of fixing parts 441 and 442 and a first assembling means 423 for fixing the fixing parts 441 and 442 to each other. The fixing parts 441 and 442 are comprised of first fixing parts 441 and second fixing parts 442 that face to each other.

Meanwhile, the substrate holder assembly 400 further has a third assembling means 415 for assembling the second fixing parts 442 with the first accommodating member 420a, and a fourth assembling means 416 for assembling the first accommodating member 420a with the second accommodating member 420b.

The first accommodating member 420a has the first hollow portion 428a open upward and downward at the inner circumference thereof. A stopper 429 protrudes at the inner upper side of the first accommodating member 420a to prevent the movement of the second accommodating member 420b.

The inner part of the second accommodating member 420b are open upward and downward, and a loading portion 431 protrudes inward at the inner circumference of the second accommodating member 420b, on which the stamp 410 and the base substrate 411 are loaded.

The elastic plate 432 is disposed between the first accommodating member 420a and the second accommodating member 420b. The movement of the elastic plate 432 is prevented as the first accommodating member 420a and the second accommodating member 420b that are assembled with each other press the elastic plate 432. In particular, the first protrusion 424a and the second protrusion 424b that protrude respectively from the surfaces of the first accommodating member 420a and the second accommodating member 420b that face to each other while the elastic plate 432 is disposed between them prevent the movement of the elastic plate 432 as the first protrusion 424a and the second protrusion 424b are pushed by force into the elastic plate 432 by the assembly of the first accommodating member 420a and the second accommodating member 420b.

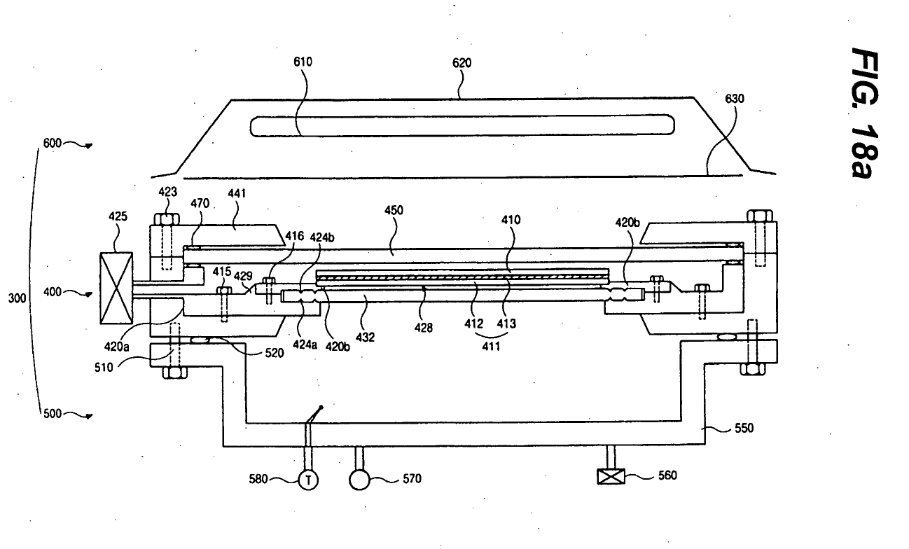

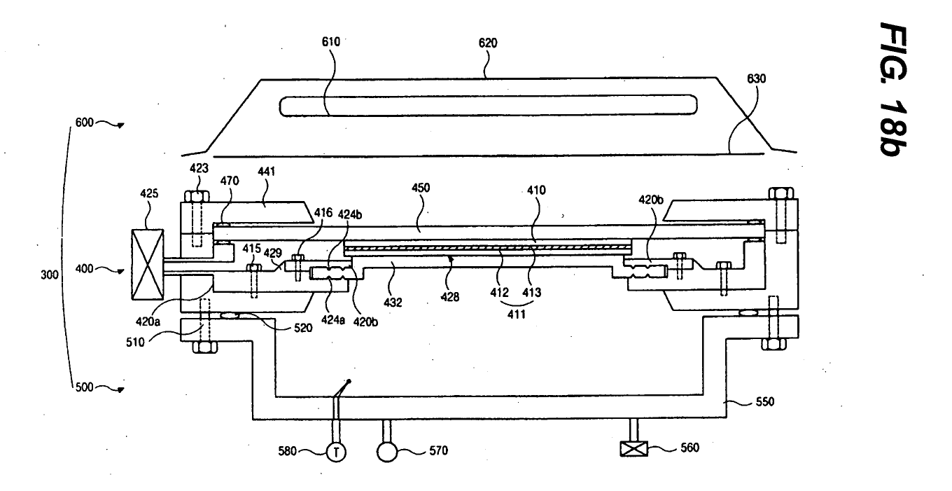

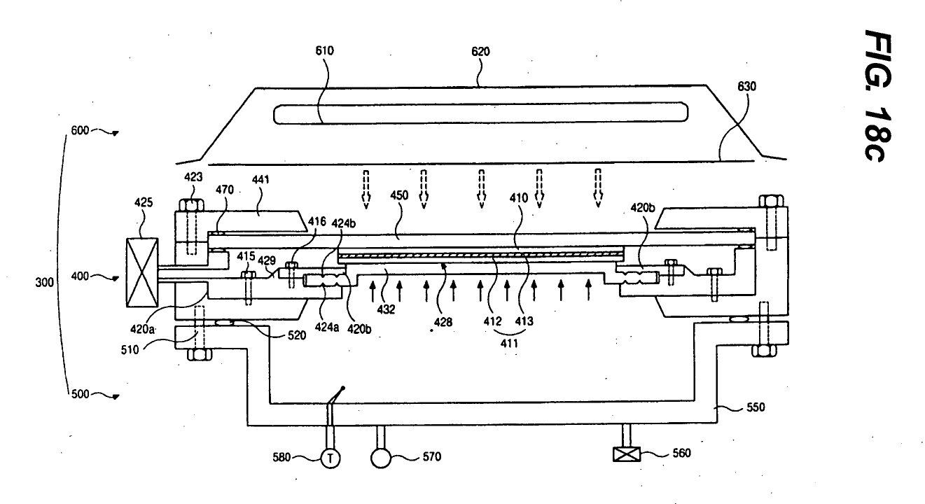

Hereinafter, the operation of the imprinting device 300 according to the first embodiment of the present invention is described with reference to FIGS. 18a through 18c.

As shown in FIG. 18a, the stamp 410 and the base substrate 411 are accommodated in the hollow portion 428 while they are loaded on the loading portion 431.

Next, as shown in FIG. 18b, the first valve 425 connected with the discharge pipe 422 begins to operate to vacuumize the first hollow portion 428.

As the first hollow portion 428 is evacuated, the elastic plate 432 is deformed toward the direction facing the transparent plate 450 so that the stamp 410 are contacted with the transparent plate 450 to push the transparent plate 450, and the transparent plate 450 applies pressure to the stamp 410 by the reaction in such a state. Accordingly, the elastic plate 431 and the transparent plate 450 push the stamp 410 and the base substrate 411, so the position of the stamp 410 and the base substrate 411 is aligned steadfastly.

Next, as shown in FIG. 18c, the second valve 560 begins to operate to raise the pressure in the chamber 550, and the light is projected through the light projection assembly 600.

The pattern of the stamp 410 is imprinted on the base substrate 411 according to the operation of the imprinting device 300 described above.

As described above, the imprinting device 300 according to the fifth embodiment of the present invention prevents the movement of the stamp 410 and the base substrate 411 with the first and the second accommodating members 420a and 420b. Thus, the pattern formed on the stamp 410 is effectively imprinted on the polymer 413 of the base substrate 411.

Sixth Embodiment

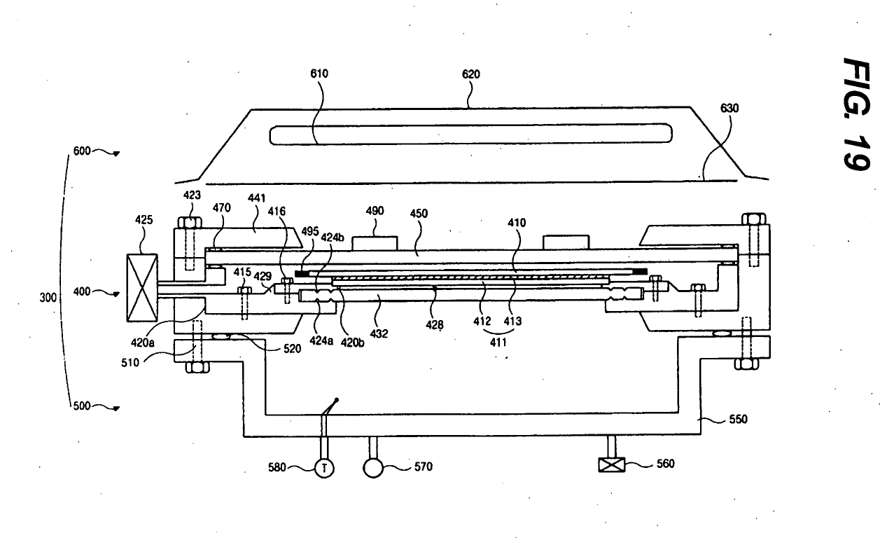

FIG. 19 shows the imprinting device 300 according to the sixth embodiment of the present invention.

The sixth embodiment of the present invention is one of the modifications of the fifth embodiment of the present invention, and the description of the parts identical to or corresponding to those in the fifth embodiment is omitted and the additional or the modified elements are described below.

The imprinting device 300 according to the sixth embodiment of the present invention aligns the position of the stamp 410 and the base substrate 411 precisely with magnetic members 490 and 495.

The first magnetic member 490 and the second magnetic member 495 control the position alignment of the stamp 410 and the base substrate 411 precisely with the mutual induction property of magnetic field.

The first magnetic member 490 is placed on the transparent plate 450, and the second magnetic member 495 is assembled with the stamp 410. The second magnetic member 495 is attached to the outer surface of the stamp 410 with adhesive. Meanwhile, the second magnetic member 495 is manufactured to the shape of a thin film that can be attached on the upper side of the stamp 410.

The magnetic fields generated respectively by the first magnetic member 490 and the second magnetic member 495 cause a mutual induction that moves the stamp 410 horizontally so as to control the position of the stamp 410 exactly.

While the stamp 410 is moved by the mutual induction of the first magnetic member 490 and the second magnetic member 495, the position of the base substrate 411 is fixed.

As mentioned above, the imprinting device 300 according to the sixth embodiment of the present invention can control the position alignment of the stamp 410 and the base substrate 411 by controlling the position of the stamp 410 with the magnetic members 490 and 495. Accordingly, the pattern formed on the stamp 410 is effectively imprinted on the polymer 413 of the base substrate 411.

Seventh Embodiment

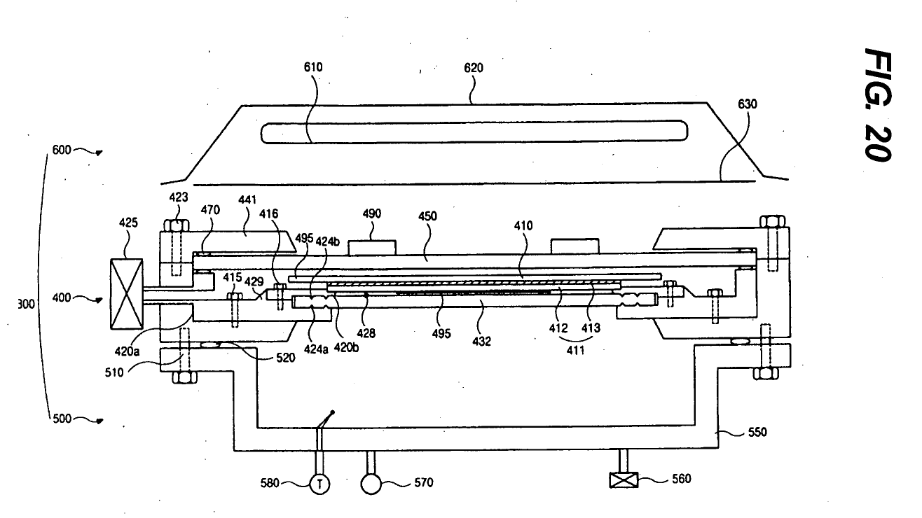

FIG. 20 shows the imprinting device 300 according to the seventh embodiment of the present invention.

The seventh embodiment of the present invention is one of the modifications of the fifth embodiment of the present invention, and the description of the parts identical to or corresponding to those in the fifth embodiment is omitted and the additional or the modified elements are described below.

As shown in the figure, the imprinting device 300 according to the seventh embodiment of the present invention aligns the position of the stamp 410 and the base substrate 411 precisely by assembling the second magnetic member 495 with the base substrate 411.

The magnetic fields generated respectively by the first magnetic member 490 and the second magnetic member 495 cause a mutual induction that moves the base substrate 411 horizontally so as to control the position of the base substrate 411 exactly.

While the base substrate 411 is moved by the mutual induction of the first magnetic member 490 and the second magnetic member 495, the position of the stamp 410 is fixed.

Meanwhile, the second magnetic member 495 preferably has the shape of a thin film that is attached to the base substrate 411.

As mentioned above, the imprinting device 300 according to the seventh embodiment of the present invention can control the position alignment of the stamp 410 and the base substrate 411 by controlling the position of the base substrate 411 with the magnetic members 490 and 495. Accordingly, the pattern formed on the stamp 410 is effectively imprinted on the polymer 413 of the base substrate 411.

Eighth Embodiment

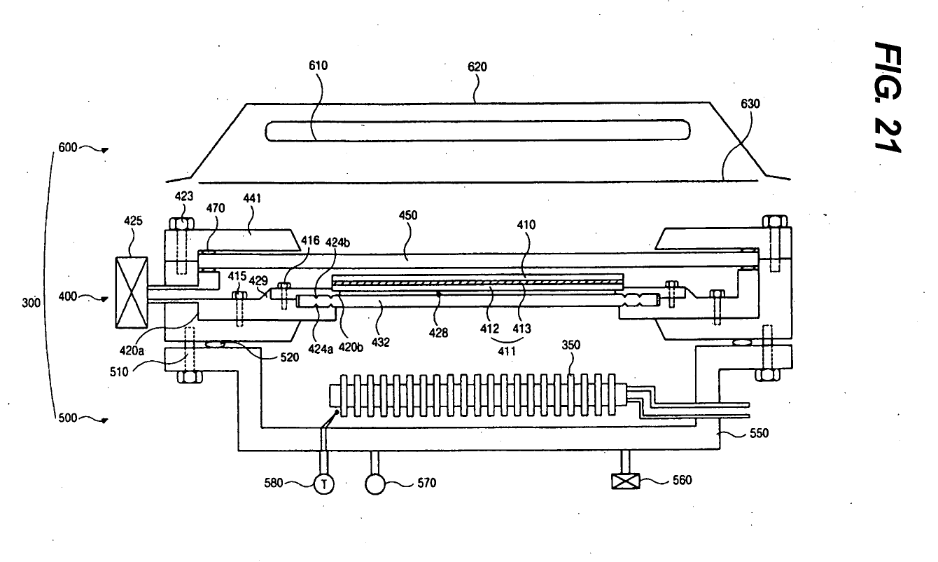

FIG. 21 shows the imprinting device 300 according to the eighth embodiment of the present invention.

The eighth embodiment of the present invention is one of the modifications of the fifth embodiment of the present invention, and the description of the parts identical to or corresponding to those in the fifth embodiment is omitted and the additional or the modified elements are described below.

The imprinting device 300 according to the eighth embodiment of the present invention has a temperature control device 350 for raising or lowering the processing temperature during the imprinting lithography process.

The temperature control device 350 installed in the chamber 550 changes the processing environment to a high temperature or a low temperature rapidly by circulating the fluid of high or low temperature.

As the fluid of high temperature circulates in the temperature control device 350 during the imprinting lithography process, the imprinting device 300 is changed to the high temperature environment rapidly to form the pattern on the polymer 313 of the base substrate 311 easily.

Moreover, as the fluid of low temperature circulates in the temperature control device 350 after the pattern has been formed, the imprinting device 300 is changed to the low temperature environment rapidly to prevent the deficiency of pattern that may be caused by the thermal expansion of the pattern of the polymer 313 that has been imprinted in the high temperature environment.

As mentioned above, the imprinting device 300 according to the eighth embodiment of the present invention is equipped with the temperature control device 350 in the chamber 550, so the temperature of the imprinting device 300 can be controlled easily to form the desired pattern easily.

Ninth Embodiment

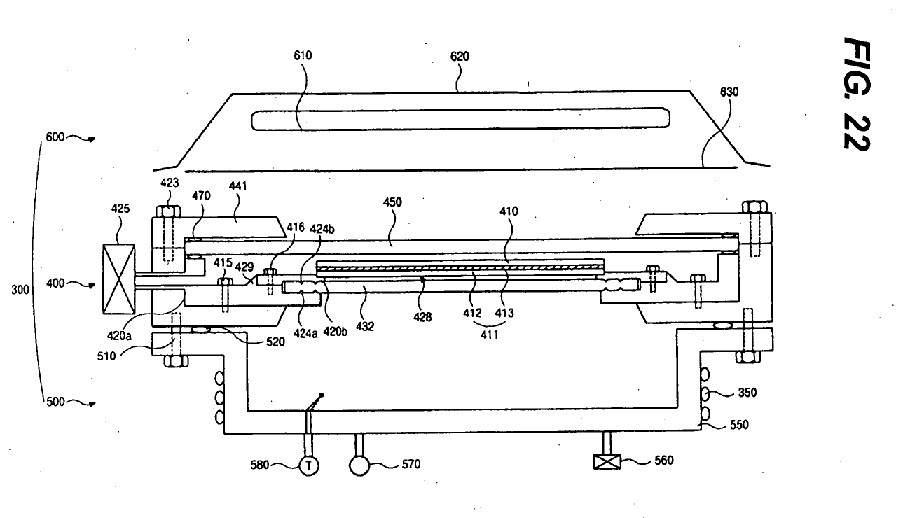

FIG. 22 shows the imprinting device 300 according to the ninth embodiment of the present invention.

The ninth embodiment of the present invention is one of the modifications of the fifth embodiment of the present invention, and the description of the parts identical to or corresponding to those in the fifth embodiment is omitted and the additional or the modified elements are described below.

The imprinting device 300 according to the ninth embodiment of the present invention has a temperature control device 350 for raising or lowering the processing temperature during the imprinting lithography process.

The temperature control device 350 installed around the chamber 550 changes the processing environment to a high temperature or a low temperature rapidly by circulating the fluid of high or low temperature.

As the fluid of high temperature circulates in the temperature control device 350 during the imprinting lithography process, the imprinting device 300 is changed to the high temperature environment rapidly to form the pattern on the polymer 313 of the base substrate 311 easily.

Moreover, as the fluid of low temperature circulates in the temperature control device 350 after the pattern has been formed, the imprinting device 300 is changed to the low temperature environment rapidly to prevent the deficiency of pattern that may be caused by the thermal expansion of the pattern of the polymer 313 that has been imprinted in the high temperature environment.

As mentioned above, the imprinting device 300 according to the ninth embodiment of the present invention is equipped with the temperature control device 350 around the chamber 550, so the temperature of the imprinting device 300 can be controlled easily to form the desired pattern easily.

According to the present invention, it is possible to form the optimal pattern of nanometer or micrometer size as the exact aligned position can be maintained during the imprinting process.

Furthermore, the imprinting device according to the present invention has a single united device that provides the ultraviolet rays or the infrared rays for hardening and provides the high pressure proper for imprinting, so it can be controlled optimally even against the diverse variables during the imprinting process.

Further, the position alignment of the stamp and the base substrate can be maintained more precisely with the auxiliary device such as the magnetic members for fixing the substrate, etc.

Moreover, the quality of process can be more improved as the temperature of the imprinting device can be controlled easily by the integrated temperature control device.

The above-described embodiments are merely the examples of the present invention, and they can be modified within the scope of the technical idea of the present invention. For example, the temperature control device according to the eighth or the ninth embodiment of the present invention can be employed in the imprinting device according to the sixth or the seventh embodiment of the present invention. Furthermore, the embodiments and the drawings are aimed to illustrate the constitution of the present invention in detail and are not aimed to define the scope of the technical idea of the present invention, and it will be understood by those skilled in the art that the present invention should not be limited to the described preferred embodiment, but various changes and modifications can be made within the spirit and the scope of the present invention. Accordingly, the scope of the present invention is not limited within the described range but the following claims and the equivalents thereof.

1. An imprinting device comprising:
means for forming a hollow portion for accommodating a stamp formed with a pattern and transparent with respect to ultraviolet rays or infrared rays, and a base substrate formed with a polymer hardened by the ultraviolet rays or the infrared rays;
an elastic plate made of an elastic material and forming a part of an inner wall of the hollow portion, the elastic plate which is so deformed by a pressure difference between inside and outside of the hollow portion that the stamp is pressed onto the polymer onto the base substrate in order that the pattern formed on a surface of the stamp is transcribed on the polymer;
a transparent plate made of a material transparent with respect to the ultraviolet rays or the infrared rays and forming a part of another inner wall facing the elastic plate at the hollow portion, the transparent plate which transmits the ultraviolet rays or the infrared rays to the polymer formed with the pattern so that the polymer is hardened; and
a means for discharging air in the hollow portion to be a low pressure state.

2. The imprinting device of claim 1, further comprising:
a sealed high-pressure chamber having at least a part of a surface of the elastic plate exposed outward of the hollow portion as an inner wall thereof; and
a pressing means for raising a pressure in the high-pressure chamber so that the elastic plate is deformed toward the inside of the hollow portion.

3. The imprinting device of claim 1, further comprising a light transmitting means for applying the ultraviolet rays or the infrared rays through the transparent plate.

4. The imprinting device of claim 3, further comprising a light source for providing the ultraviolet rays or the infrared rays.

5. The imprinting device of claim 1, further comprising a temperature control device for controlling a temperature of the pattern of the polymer.

6. The imprinting device of claim 1, further comprising an auxiliary aligning means for fixing the stamp and the base substrate so that a position alignment of the stamp and the base substrate accommodated in the hollow portion is maintained.

7. The imprinting device of claim 6, wherein the auxiliary aligning means is so constructed as to use a magnetic force between a first magnetic member fixed on a certain position on the inner wall of the hollow portion and a second magnetic member assembled with the stamp or the base substrate.
